(19) United States
(12) Patent Application Publication
(10) Pub. No.: US 2024/0208308 A1
(43) Pub. Date: Jun. 27, 2024

(54) MODULAR TRUCK BED CAP

(71) Applicants: Enrique Giner, Mission Viejo, CA (US); Alejandro Portabales, Trabuco Canyon, CA (US)

(72) Inventors: Enrique Giner, Mission Viejo, CA (US); Alejandro Portabales, Trabuco Canyon, CA (US)

(21) Appl. No.: 18/397,515

(22) Filed: Dec. 27, 2023

Related U.S. Application Data
(60) Provisional application No. 63/477,368, filed on Dec. 27, 2022.

(51) Int. Cl. B60J 7/16; B60J 7/10

(52) U.S. Cl. CPC B60J 7/1607; B60J 7/106

(57) ABSTRACT

A modular truck cap may be formed from multiple sections or panels, such as a front panel, a rear panel, a left panel, a right panel, and one or more top panels. The panels may be sized for installation and removal by a single individual. Panels may be connected to a truck bed using tool-less fasteners, such as quick release latches. Panels may interlock with compressed embedded seals to minimize intrusion of water, air or dirt. Side panels may be formed to flare laterally outward for increased enclosed cap width and volume.

### TECHNICAL FIELD

Embodiments of the present disclosure relate in general to a cap or cover for e.g. the bed of a pickup truck.

### BACKGROUND

Caps or covers for the beds of pickup trucks are increasingly popular as a solution to enclose and protect the contents of an open vehicle bed, such as the bed of a pickup truck. Traditional caps are formed from a large cover that may be set and secured onto the edges of a pickup truck bed. The cap can be removably installed.

However, many traditional truck caps are formed primarily from a single large, heavy component that may be very cumbersome to install or uninstall. Installation and uninstallation often requires multiple individuals and/or special equipment. The installation and uninstallation can be so cumbersome and fraught with risk of damage to the vehicle, that many users never uninstall the cap even when it would otherwise be desirable to do so. When not in use, the caps may be difficult to store, requiring a large area. Shipping of traditional caps may be expensive and not space efficient. Traditional caps also typically provide a fixed configuration while in use, with little or no ability to adapt the form or function of the cap based on a user's changing needs.

### SUMMARY

A modular truck cap is provided. The cap is comprised of multiple sections or panels, each of which is preferably sized for convenient installation or removal by a single individual.

In some aspects, the techniques described herein relate to a modular truck cap for removable installation on a bed of a truck, including: a front section removably mountable to extend upwards from a front rail of a truck bed; a left section removably mountable to extend upwards from a left side rail of the truck bed; a right section removably mountable to extend upwards from a right side rail of the truck bed; a rear section removably mountable to extend upwards from a rear tailgate of the truck bed; and one or more roof sections collectively covering at least a portion of a space defined by the front section, rear section, left section and right section.

In some aspects, the front section is removably mountable to a front rail of a truck bed; the left section is removably mountable to a left side rail of the truck bed; the right section is removably mountable to the right side rail of the truck bed; and the rear section is removably mountable to at least the left section and the right section.

In some aspects, the techniques described herein relate to a modular truck cap, in which the one or more roof sections include a front top section and a rear top section.

In some aspects, the techniques described herein relate to a modular truck cap, further including one or more latches removably attaching the front section, left section and right section to the pickup truck bed.

In some aspects, the techniques described herein relate to a modular truck cap, wherein each latch is pivotably mounted to one of said sections to move between a stowed configuration in which the latch pivots upward against the section to which it is mounted, and a deployed configuration in which the latch is pivoted downward away from the section to which it is mounted.

In some aspects, the techniques described herein relate to a modular truck cap, further including one or more mounting points secured to the bed of the truck, wherein each of said latches is mounted to one of the sections, and each of said latches engages one or more of said mounting points to secure the section to which it is mounted to the bed of the truck.

In some aspects, the techniques described herein relate to a modular truck cap, wherein the mounting points include one or more sections of strut, L angle, I beam or U channel affixed to front, left and right sides of the bed.

In some aspects, the techniques described herein relate to a modular truck cap, wherein the sections are included of fiberglass.

In some aspects, the techniques described herein relate to a modular truck cap, wherein the sections are each formed via molding.

In some aspects, the techniques described herein relate to a modular truck cap, wherein the left section and the right section, when installed, each curve laterally outward from points at which said left section and right section meet the bed.

In some aspects, the techniques described herein relate to a modular truck cap, wherein said front section adjoins with the left section, right section and at least one of the roof sections via portions of said sections mating in tongue and groove structures.

In some aspects, the techniques described herein relate to a modular truck cap, further including one or more seals compressed within the tongue and groove structures when assembled.

In some aspects, the techniques described herein relate to a modular truck cap, further including a replacement section that may be swapped in place of a counterpart section including one or more of the front section, rear section, left section, right section or roof sections; wherein structure of the replacement section differs from the counterpart section.

In some aspects, the techniques described herein relate to a modular truck cap, wherein the counterpart section is opaque and the replacement section includes a window.

In some aspects, the techniques described herein relate to a modular truck cap, wherein the counterpart section is a side section and the replacement section is a side section including a lockable door enclosing one or more storage compartments.

In some aspects, the techniques described herein relate to a modular truck cap, wherein the counterpart section is a roof section and the replacement section is a roof section including solar panels.

In some aspects, the techniques described herein relate to a modular truck cap, wherein the counterpart section is a roof section and the replacement section is a roof section movable between a lowered configuration enclosing the truck cap, and one or more raised configurations allowing open communication between the truck bed and areas outside the truck cap.

In some aspects, the techniques described herein relate to a modular truck cap, wherein the replacement section includes configurable legs which may be deployed from a bottom side of the replacement section and connected to one or more of the side sections.

In some aspects, the techniques described herein relate to a method for installing a truck cap on a truck bed, including: standing a front section on a front truck bed rail, the front section including a forward surface and a shroud extending rearward, the shroud having lower portions contacting portions of left and right truck bed rails; standing a rear section including a rearward surface and a shroud extending forward, on a tailgate of the truck and portions of the left and right truck bed rails; interlocking a left section with the front section and the rear section, wherein the left section rests on the left truck bed rail; and interlocking a right section with the front section and the rear section, wherein the right section rests on the right truck bed rail.

In some aspects, the techniques described herein relate to a method, further including interlocking one or more top sections with the left section, the right section, and at least one of the front section and the rear section.

In some aspects, the techniques described herein relate to a method, further including securing the front section, the rear section, the left section and the right section to the truck bed using a tool-less removable fastener.

Various other objects, features, aspects, and advantages of the present invention and embodiments will become more apparent from the following detailed description of preferred embodiments, along with the accompanying drawings in which like numerals represent like components.

### BRIEF DESCRIPTION OF THE FIGURES

FIG. 1 is an exploded upper perspective view of a modular truck cap, in accordance with a first embodiment.

FIG. 2 is an exploded lower perspective view of the modular truck cap.

FIG. 3 is a top plan view of the exploded modular truck cap.

FIG. 4 is a side view of the exploded modular truck cap.

FIG. 5 is a front view of the exploded modular truck cap.

FIG. 6 is a flow chart of a process for modular truck cap installation.

FIG. 7 is a rear perspective view of a cutaway truck bed having a front panel of a modular truck cap installed hereon.

FIG. 8 is a rear perspective view of a cutaway truck bed having front and rear panels of a modular truck cap installed hereon.

FIG. 9 is a rear perspective view of a cutaway truck bed having front, rear and side panels of a modular truck cap installed hereon.

FIG. 10A is a rear perspective view of a cutaway truck bed having front, rear, side and forward top panels of a modular truck cap installed hereon.

FIG. 10B is a rear perspective view of a cutaway truck bed having a modular truck cap fully installed hereon.

FIG. 11 is a side view of a first latch mechanism for joining modular truck cap panels to a truck bed rail.

FIG. 12 is a perspective view of the first latch mechanism.

FIG. 13A is a perspective view of a second latch mechanism in a stowed position.

FIG. 13B is a perspective view of the second latch mechanism in a deployed position.

FIG. 14A is a perspective cutaway view of a latch mechanism adapted for engagement with a U-channel mounting point, in a stowed position.

FIG. 14B is a perspective cutaway view of the latch mechanism of FIG. 14A, engaged with a U-channel mounting point.

FIG. 15 is a figurative cross-sectional view of an interface between adjacent panels, in accordance with one embodiment.

FIG. 16 is a figurative cross-sectional view of the interface of FIG. 15, with panels in place with gasket compressed.

FIG. 17 is a figurative cross-sectional view of an interface between adjacent panels, in according with a second embodiment.

FIG. 18 is a figurative illustration of a modular truck cap with interchanging of top and side panels.

FIG. 19A is a perspective view of a modular truck cap having a pop-up top panel in a half-raised position.

FIG. 19B is a perspective view of a modular truck cap having a pop-up top panel in a fully-raised position.

FIG. 19C is a perspective view of the modular truck cap with FIG. 19B, having a mesh skirt enclosing the open top.

FIG. 20A is a rear view of a conventional truck bed cap rear profile.

FIG. 20B is a rear view of a modular truck bed cap having expanded width.

### DETAILED DESCRIPTION OF THE DRAWINGS

While this invention is susceptible to embodiment in many different forms, there are shown in the drawings and will be described in detail herein several specific embodiments, with the understanding that the present disclosure is to be considered as an exemplification of the principles of the invention to enable any person skilled in the art to make and use the invention, and is not intended to limit the invention to the embodiments illustrated.

A truck cap may be formed from a modular construction, having multiple sections, or panels, that may be individually installed and removed. Each of the panels is preferably sized for easy handling by a single individual. In preferred embodiments, the modular truck cap will be formed from at least five panels, with some preferred embodiments formed from six panels.

The description herein may use the term panel to refer to a modular component of the truck cap which forms a material portion of the assembled enclosure surface, but is sized for easy handling. The term panel is intended to refer broadly to sections of a multi-section structure. While some panels may be generally flat, it is contemplated and understood that panels may assume a variety of shapes, constructions and materials, and no limitation with regard to the shape or form of the component should be inferred through use of the term panel.

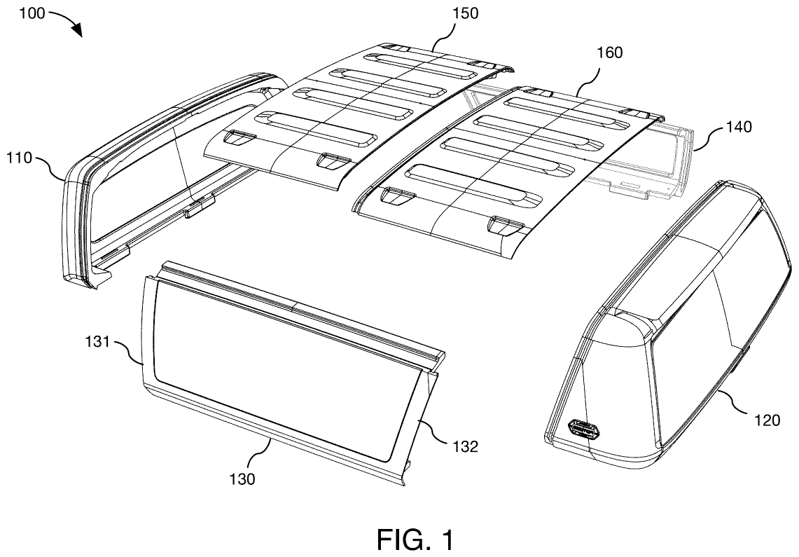

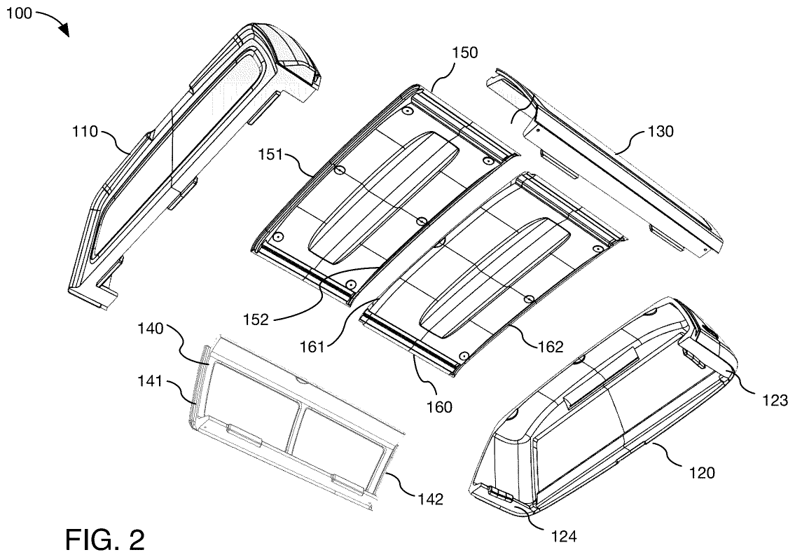

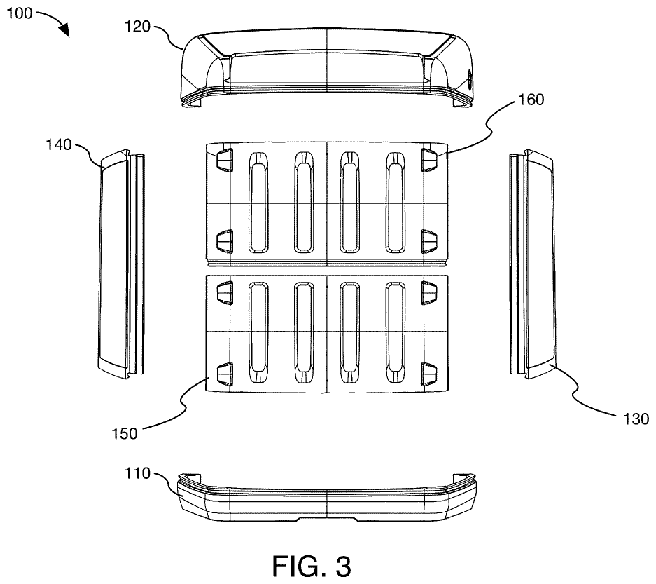

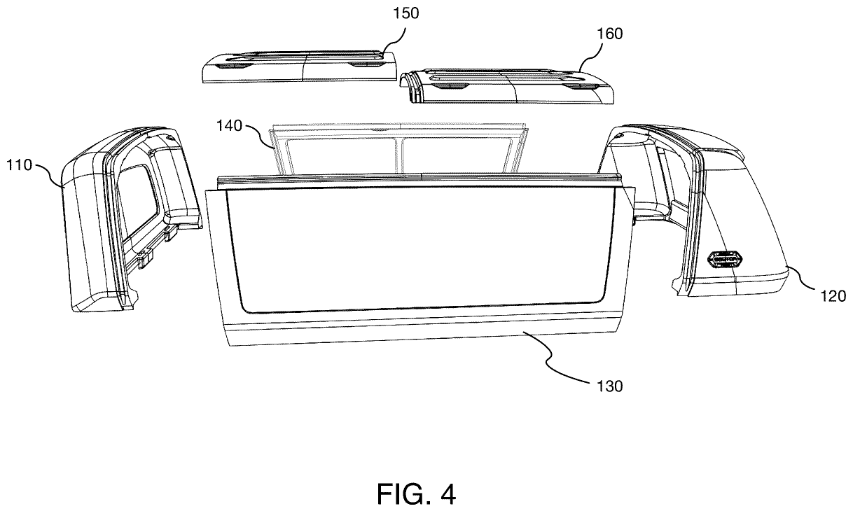

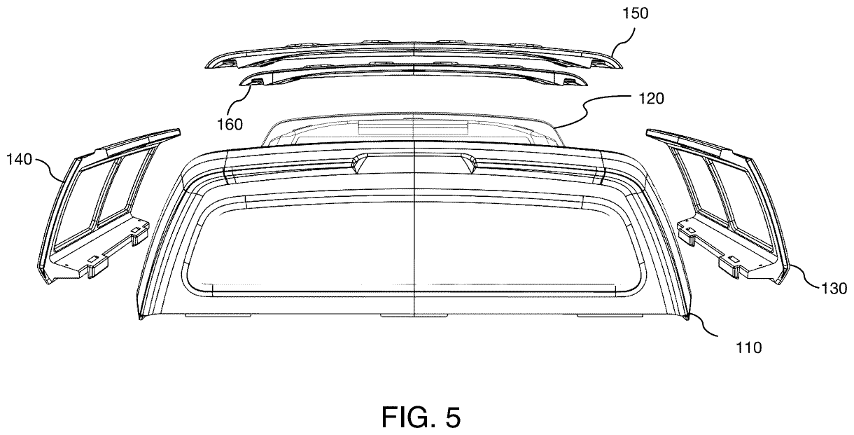

FIG. 1 illustrates a modular truck cap 100, in exploded perspective view. Modular truck cap 100 is formed from front panel 110, rear panel 120, left side panel 130, right side panel 140, front top panel 150 and rear top panel 160. Front panel 110 may be alternatively referred to as a front section of the modular cap; similarly, rear panel 120 may be referred to as a rear section, left side panel 130 may be referred to as a left side section, right side panel 140 may be referred to as a right side section, front top panel 150 may be referred to as a front top section, and rear top panel 160 may be referred to as a rear top section. The exploded view of modular truck cap 100 is illustrated in a bottom perspective view in FIG. 2; a top plan view in FIG. 3; a left side elevation in FIG. 4; and a front elevation in FIG. 5.

Panels 110, 120, 130, 140, 150 and 160 are preferably constructed with a size, material and weight facilitating easy handling by a single individual. For example, panels 110, 120, 130, 140, 150 and 160 may be formed primarily from a combination of fiberglass, plastics and plexiglass.

The modular truck cap panels 110, 120, 130, 140, 150 and 160 may in some embodiments be formed from composite fiberglass, providing desirable strength, durability and light weight. Portions of panels may be formed from plexiglass if it is desired e.g. to provide visibility into the assembled cap from outside, to allow ambient light to pass into the installed cap for better contents visibility, or to permit a driver to see through front panel 110 and rear panel 120 using a rear view mirror. Other materials and fabrication techniques that may be used to form modular truck cap panels include injected molded plastic, rotational molding parts, vacuum formed parts, compression forming, pouring, aluminum, stainless steel, or various combinations thereof. Depending upon the manufacturing process selected, each of the modular panels could be manufactured as a single or multi-part component.

Some embodiments of the modular truck cap described herein may provide a number of advantages over traditional, unitary truck caps. As mentioned, individual panels of the modular truck cap may be significantly smaller and lighter than a single unitary truck cap, greatly facilitating installation and removal of the modular truck cap from a truck. The smaller size of modular panels may also facilitate storage of the modular truck cap in a smaller area than would be required for a traditional, unitary truck cap. Panels may be nested against one another for storage. The significantly reduced handling burden and storage footprint may encourage users to more readily remove and install the modular truck cap, such that users can more easily alternate between the advantages of an enclosed truck bed and the advantages of an open truck bed.

Modular constructions as described herein may also be highly desirable due to reduced burden of packaging and shipping the truck cap. Traditional, unitary construction truck caps may require specialized and costly packaging and shipping arrangements due to their large size, heavy weight and complex geometries. By contrast, the smaller and relatively flat components of certain modular truck cap embodiments may facilitate simpler packaging and greater options for shipping.

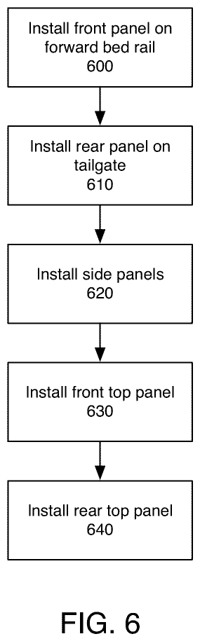

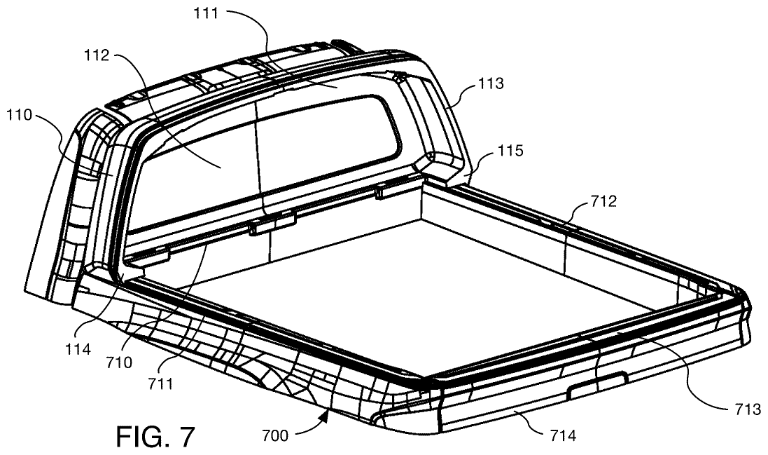

The panels 110, 120, 130, 140, 150 and 160 may be installed one at a time, preferably by a single person without tools, to form a unitary cover over an open area such as the bed of a pickup truck. FIG. 6 illustrates a process for modular truck cap assembly. In step 600, front panel 110 is positioned to rest atop, and secured to, front bed rail 710 of truck bed 700 (shown in partial cutaway view). Front panel 110 includes a forward surface 111 and plexiglass window 112, resting substantially flush against a truck cabin rear window, and a shroud 113 extending rearward from forward surface 111. Lower portion 114 and lower portion 115 of shroud 113 also rest upon left truck bed rail 711 and right truck bed rail 712, respectively, facilitating stable free-standing of front panel 110 when placed on the truck bed rails during assembly. Front panel 110 can then be secured to the bed rails using, e.g., latches or other removable fasteners, as described in greater detail hereinbelow. In some embodiments, at least two latches will be utilized to secure front panel 110 to front bed rail 710. In some embodiments, one or more additional latches may be provided to secure, e.g., lower portion 114 to left truck bed rail 711, and to secure lower portion 115 to right truck bed rail 712.

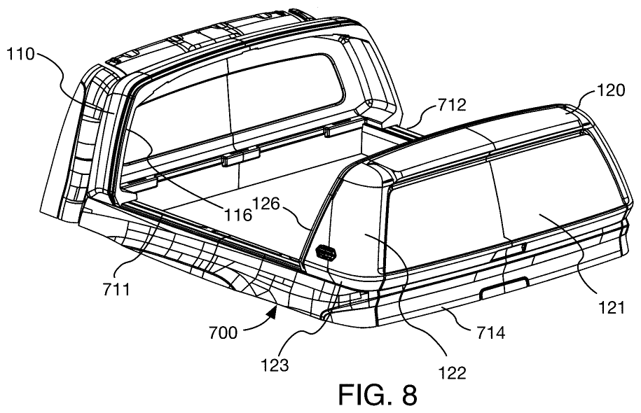

In step 610, rear panel 120 is positioned to rest atop rear bed rail 713 (formed by tailgate 714, of truck bed 700), as shown in FIG. 8. Rear panel 120 includes rear surface 121, and shroud 122 extending forward from rear surface 121. Lower portion 123 and lower portion 124 of shroud 122 also rest upon left truck bed rail 711 and right truck bed rail 712, respectively, facilitating stable free-standing of rear panel 120 when placed on the truck bed rails during assembly. Rear panel 120 may then be secured to the truck bed rails using, e.g., latches, as described elsewhere herein.

In typical embodiments, it may be desirable to avoid latching rear panel 120 to tailgate 714, so that tailgate 714 can be readily opened and closed to provide access to areas within modular truck cap 100 while modular truck cap 100 is installed. Accordingly, it may be desirable for shroud 122 to extend significantly forward of rear surface 121, providing additional area for secure latching of lower portion 123 to left truck bed rail 711, and of lower portion 124 to right truck bed rail 712.

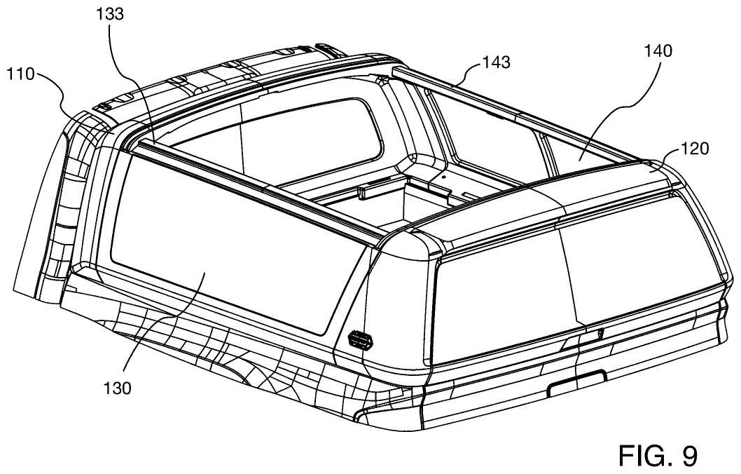

In step 620, left side panel 130 is positioned to rest on, and secured to, left side bed rail 711, and right side panel 140 is positioned to rest on, and secured to, right truck bed rail 712, as illustrated in FIG. 9. Forward edge 131 of left side panel 130 overlies a portion of panel lip 116 extending around a rearward edge of front panel 110, while rear edge 132 of left side panel 130 overlies a portion of panel lip 126 extending around a forward edge of rear panel 120. Similarly, right side panel 140 is positioned to rest on, and secured to, right truck bed rail 712, with forward edge 141 of right side panel 140 overlying a portion of panel lip 116 of front panel 110, and rear edge 142 of right side panel 140 overlying a portion of panel lip 126 of rear panel 120. Such an overlapping panel structure may help reduce incursion of water, dust or wind into enclosed areas of truck bed 700.

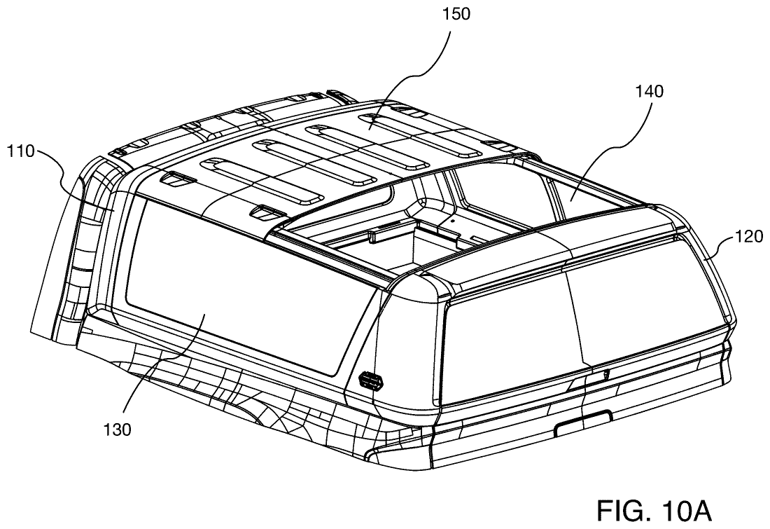

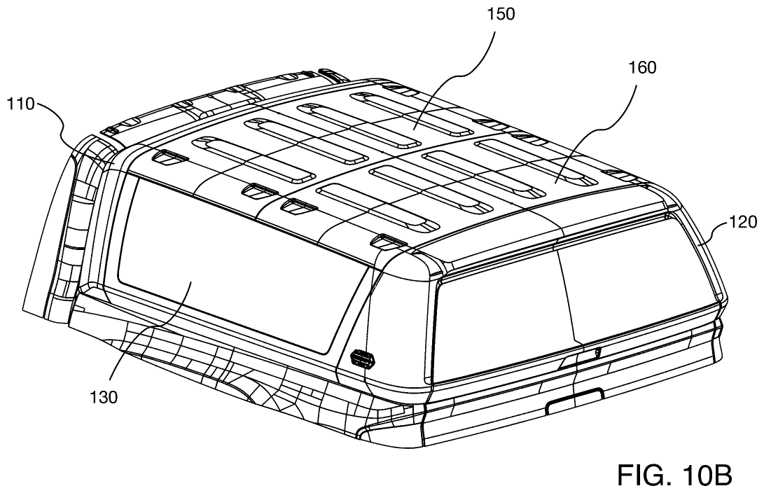

In step 630, front top panel 150 is positioned, spanning top portion 133 of left side panel 130 and top portion 143 of right side panel 140, as illustrated in FIG. 10A. Additionally, forward edge 151 of front top panel 150 overlies a portion of panel lip 116 of front panel 110. Once positioned, front top panel 150 can be secured to front panel 110, rear panel 120 and left side panel 130, e.g. using latches or other fastening mechanisms or techniques as described elsewhere herein.

In step 640, rear top panel 160 is positioned, spanning top portion 133 of left side panel 130 and top portion 143 of right side panel 140. Additionally forward edge 161 of rear top panel 160 underlies rear edge 152 of front top panel 150. Rear edge 162 of rear top panel 160 overlies a portion of lip 126 of rear panel 120. Once positioned, rear top panel 160 can be secured to rear panel 120, left side panel 130 and right side panel 140, e.g. using latches or other fastening mechanisms or techniques as described elsewhere herein. The fully-assembled modular cap 100 is illustrated in FIG. 10B.

While modular truck cap 100 includes multiple roof panels (i.e. front top panel 150 and rear top panel 160), in other embodiments, a single roof panel may be provided. While a single, unitary roof panel may provide for a physically larger roof panel than a split roof panel design (and therefore somewhat more difficult for handling and storage), a single unitary roof panel may avoid requiring a joint between roof panels that may be particularly vulnerable to incursion of e.g. dust or water.

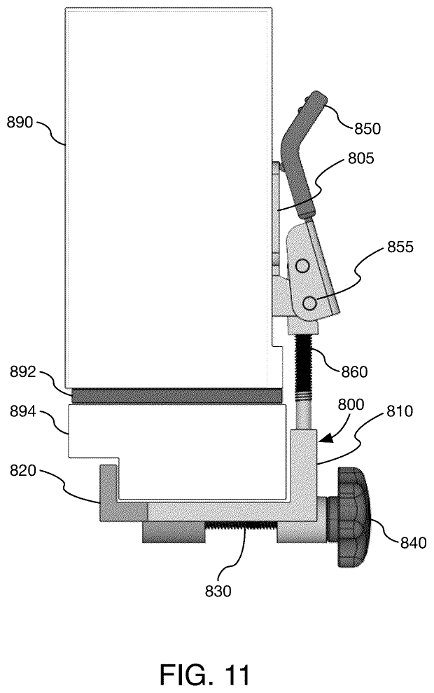

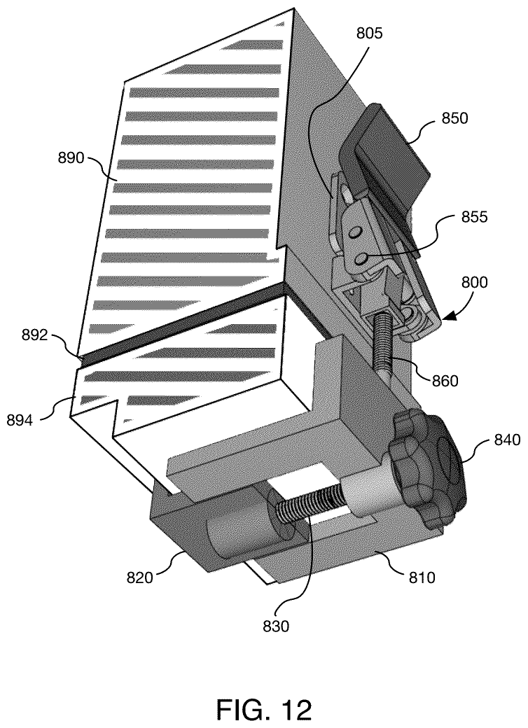

Panels resting on the truck may be secured to the truck bed in a variety of manners, preferably using tool-less removable fasteners. In some embodiments, panels are secured to truck bed rails via a removable latch. Latches may be adjustable to accommodate different sizing and configuration of truck beds. FIG. 11 shows an example latch mechanism that may be utilized to secure a panel to a truck bed rail, without tools, in a side elevation view of the latch securing a cross-section of a panel to a cross-section of a truck bed rail. FIG. 12 shows a perspective view of the same latch.

Latch 800 includes a mounting component 805 that is affixed to cap panel 890 towards the lower edge of panel 890, proximate an edge where panel 890 rests on bed rail 894, on a surface of panel 890 that faces inward towards a truck bed. Gasket 892 is mounted to an underside of panel 890, providing improved resistance to passage of water, air or dirt between panel 890 and bed rail 894, while also inhibiting scratching or wear that might otherwise be caused by contact between panel 890 and bed rail 894. Mounting component 805 may be secured to panel 890 via, e.g., adhesive, screws, bolts, rivets, welding, or other known techniques for securing components of an assembly, which may depend at least in part upon the material from which panel 890 is formed. Handle 850 may be pivoted upward around hinge 855 in order to pull clamp jaw 810 and clamp jaw 820 upward such that they may be tightened around bed rail 894 (thereby securing panel 890 to bed rail 894). Alternatively, handle 850 provides a cam that may be pivoted downward around hinge 855, to lower clamp jaw 810 and clamp jaw 820 such that they have clearance below bed rail 894 and can be pivoted inward with a volume enclosed by the cap, thereby enabling removal of panel 890 from bed rail 894. The clamp mechanism formed from clamp jaw 810 and clamp jaw 820 may also be rotated around screw 860 to adjust the distance between handle 850 and clamp jaw 810, thereby facilitating installation on bed rail 894 having a variety of different sizes.

Once clamp jaw 810 and clamp jaw 820 are positioned around bed rail 894, handle 840, which is attached to screw 830, may be rotated to tighten clamp jaw 810 and clamp jaw 820 around bed rail 894 (shown in cross-section in FIG. 8), such that latch 800 secures panel 890 to bed rail 894. Likewise, handle 840 may be used to loosen screw 830, and handle 850 may be pivoted to a downward position, facilitating removal of clamp jaw 810 and clamp jaw 820 from bed rail 894, such that panel 890 may be removed from bed rail 894. Meanwhile, the adjustable nature of the bed rail clamp assembly enables the mechanism to accommodate a variety of different bed rail dimensions with a single part, that is operable without tools for quick and easy installation and removal.

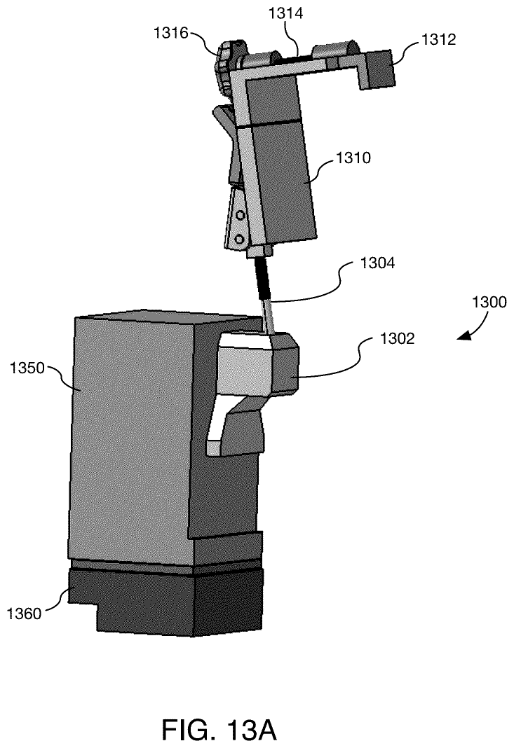

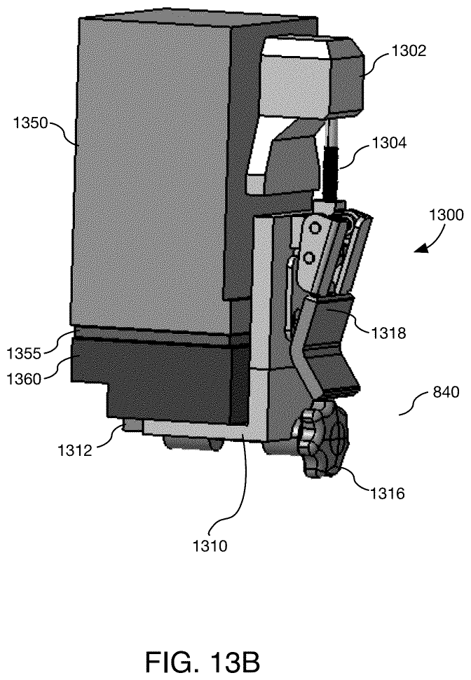

FIG. 13A illustrates an alternative latch design, in a stowed position. The latch mechanism of FIG. 13A is flipped upward, flush against the panel on which it is installed. This position may be used when the panel is not in use or being installed, such that the latch does not hang down from the panel. This may help in reducing risk of damage to the latch itself during handling of the panel, as well as possible damage to a vehicle on which the panel is being installed or removed if a hanging latch is inadvertently scraped across a surface of the vehicle. The latch may be retained in a stowed, up position by gravity (to the extent the panels may be stored and transported in a flat orientation with the latch on top, resting on the panel itself), and/or via a friction mechanism internal to the latch. In other embodiments, the latch could rest in a retaining slot internal to a hinge mechanism in the latch base, wherein the latch must be lifted out of the slot against friction and/or gravity before it can be rotated downward.

In particular, latch 1300 includes latch base 1302, which is secured to panel 1350 (a small portion of which is shown in FIG. 13A). Panel 1350 is resting on bed rail 1360, such as when a panel is positioned during installation. Threaded shaft 1304 extends from, and is pivotably attached at a first end to, latch base 1302. Clamp base 1310 is secured to a second end, opposite the first end, of threaded shaft 1304. The threading of threaded shaft 1304 enables ready adjustment of the length between latch base 1302 and clamp base 1310, thereby accommodating a variety of truck bed rail dimensions. Clamp base 1310 engages with clamp jaw 1312 via screw 1314, which may be rotated using knob 1316 to tighten and loosen clamp jaw 1312.

FIG. 13B illustrates latch 1300 in a deployed position, when used to secure panel 1350 to bed rail 1360. Threaded shaft 1304 is pivoted downward towards bed rail 1360. Cam handle 1318 can be pivoted to pull clamp base 1310 upward against an underside of bed rail 1360, compressing a gasket 1355 installed in an underside of panel 1350 to minimize incursion of water, air, dust or other materials between installed panel 1350 and bed rail 1360. Knob 1316 can then be turned to tighten clamp jaw 1312 and clamp base 1310 around bed rail 1360, further securing panel 1350 and bed rail 1360 together.

While engagement of latch mechanisms such as latch 800 or latch 1300 may facilitate securing of panels directly to truck beds having a variety of truck bed rail geometries, in some circumstances, it may be desirable to install mounting structures to e.g. the sides and front of the truck bed, such as C-shaped struts, L angle brackets, and I beam or a U channel. These mounting structures may then remain in place as the modular truck cap panels are installed and removed repeatedly over time. Such an arrangement may allow for use of a simplified, universal quick release latch on the module truck cap panels, which readily engage with the universal bed mounting structure, facilitating reliable operation and use with a wide variety of truck bed geometries.

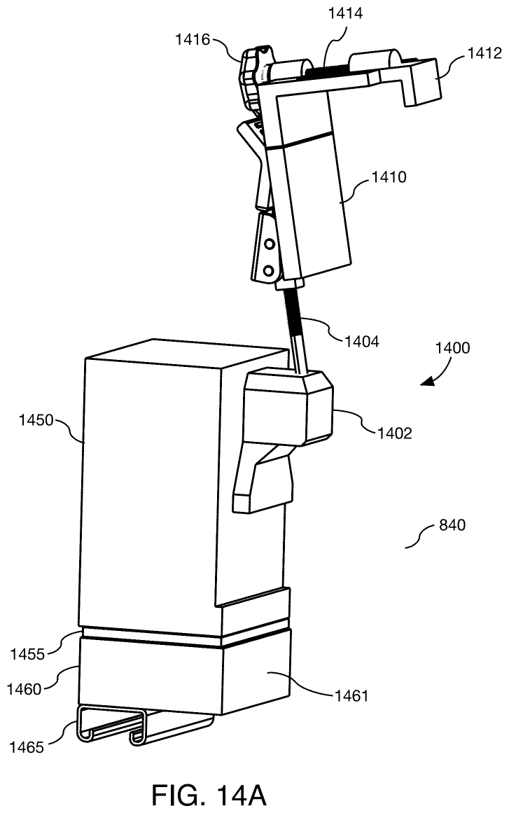

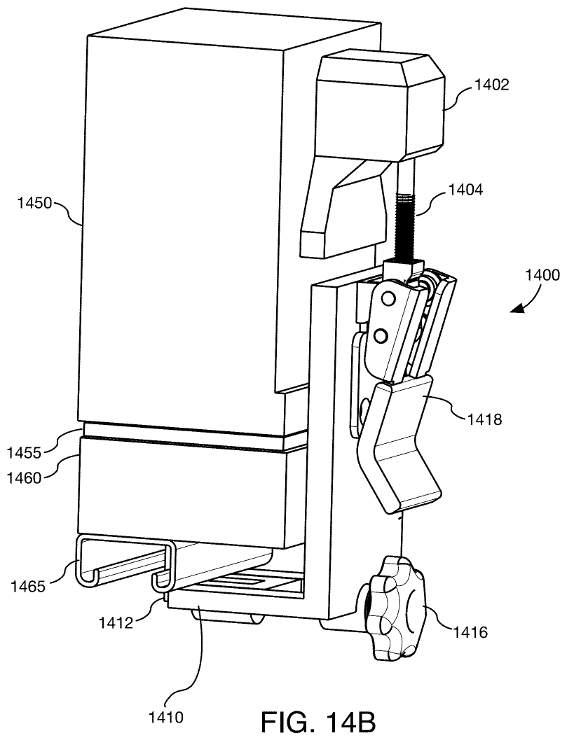

FIG. 14A illustrates an exemplary embodiment of a simplified universal latch in combination with a U-channel bracket. Latch 1400 includes latch base 1402, which is secured to panel 1450 (a small portion of which is shown in FIG. 14A in cutaway view). Panel 1450 is resting on bed rail 1460, separated by gasket 1455, such as when a panel is positioned during installation. Threaded shaft 1404 extends from, and is pivotably attached at a first end to, latch base 1402. Clamp base 1410 is secured to a second end, opposite the first end, of threaded shaft 1404. The threading of threaded shaft 1404 enables ready adjustment of the length between latch base 1402 and clamp base 1410, thereby accommodating a variety of truck bed rail dimensions. Clamp base 1410 engages with clamp jaw 1412 via screw 1414, which may be rotated using knob 1416 to tighten and loosen clamp jaw 1412. U channel 1465 is mounted to an underside of truck bed rail 1460, inset from an inside edge 1461 by a distance facilitating engagement of clamp jaw 1412 with U channel 1465. In some embodiments, a single length of U-channel 1465 may run continuously along the length of a truck bed rail, allowing maximum flexibility in positioning of panels or other objects latched to U-channel 1465. In other embodiments, the U-channel may be formed from multiple sections, which need not be continuous, each providing a mounting point for engagement of a latch at a particular position or region of the truck bed rail.

FIG. 14B illustrates latch 1400 in a deployed position, when used to secure panel 1450 to bed rail 1460. Threaded shaft 1404 is pivoted downward towards bed rail 1360. Cam handle 1418 can be pivoted to pull clamp base 1410 upward against an underside of bed rail 1460, with clamp jaw 1412 engaging into u channel 1465, compressing a gasket 1455 installed in an underside of panel 1450 to minimize incursion of water, air, dust or other materials between installed panel 1450 and bed rail 1460. Knob 1416 can then be turned to tighten clamp jaw 1412 and clamp base 1410 against U channel 1465, further securing panel 1450 and bed rail 1460 together.

In addition to securing panels to the truck bed rails, panels are also secured to one another. Various joining mechanisms may also be used to join two panels to one another. In some embodiments, panels may be joined together using a clamp, a sliding joint, a lock-latch, screws, toggle clamps or latches, or t-handle screw mechanisms. Preferably panels are joined together using mechanisms that can be readily attached and detached without requiring the use of tools. In some embodiments, a latch mechanism similar to latch 800 or latch 1300 could be used to secure panels to one another, as well as the truck bed rails.

As mentioned above, to maximize seal strength and minimize intrusion of water, dirt or air, secure seals or gaskets may be provided between each of the panels, and between the modular truck cap components and the truck bed. Preferably, seals are designed to bend in one direction, and are installed within grooves used to interlock cap parts. There panels overlap, one of the panels may form a channel, with the other panel having a tongue or groove sized to mate within the channel to interlock the parts together. The panel grooves may be recessed, protruding, overlapping, or raised with a tongue in groove style, while the channel could be rectangular, triangular, trapezoidal, round, oval or organic in shape. In addition to minimizing incursion of water, air or dirt, such interlocking panel configurations may improve strength and rigidity of the assembled structure, potentially enabling carrying of substantial roof loads, roof racks and roof tents.

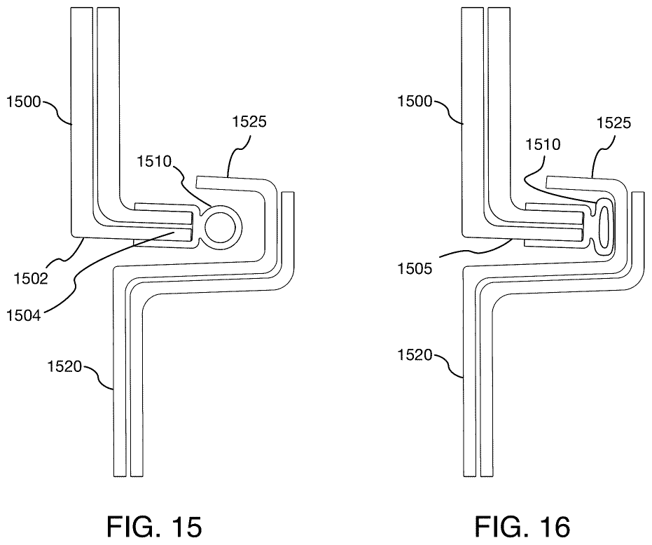

FIG. 15 is a schematic cross-sectional cutaway view of an exemplary mechanism for joining adjacent panels. Panel 1500 is formed having one edge 1502 with a lip 1504 extending at a right angle from the primary direction in which panel 1500 extends. A gasket 1510 is mounted along lip 1504, preferably including an elastic compressible hollow tube. Panel 1520 has a U-channel 1525 formed at an end proximate panel 1500. Lip 1504 and gasket 1510 may be inserted into U-channel 1525. FIG. 16 illustrates the arrangement of FIG. 15, whereupon lip 1504 and gasket 1510 have been fully inserted into u-channel 1525, such that panel 1500 and panel 1520 form a mostly continuous exterior surface. Gasket 1510 compresses within u-channel 1525, such that gasket 1510 and lip 1504 inhibit incursion of water, air or dirt between panel 1500 and panel 1520.

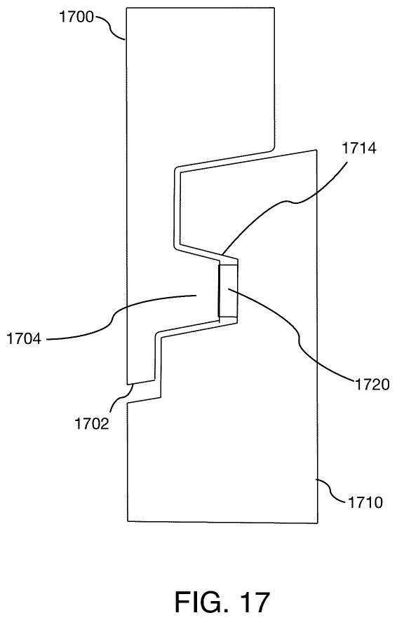

FIG. 17 illustrates another exemplary structure shown in cutaway cross-sectional view, for minimizing incursion of water, air or dirt between adjacent panels, using panels terminating with mating a trapezoidal cross-sections. In particular, panel 1700 terminates at one edge 1702 having a trapezoidal ridge 1704 extending along it. Panel 1710 slightly overlaps panel 1700, with trapezoidal channel 1714 extending along edge 1712. Trapezoidal ridge 1704 is dimensioned to mate with trapezoidal channel 1714. Gasket 1720 is formed from a length of elastic compressible material running within trapezoidal channel 1714. The trapezoidal shape of trapezoidal ridge 1704 facilitates engagement within trapezoidal channel 1714 when aligning panel 1700 and panel 1710. The overlapping structures, combined with gasket 1720, act to avoid or minimize intrusion of water, air and dirt between panel 1700 and panel 1710.

In addition to facilitating storage and assembly of the modular cap, modular constructions as described herein can also enable flexible cap functionality. In some embodiments, options may be provided for assembling a cap using different, interchangeable panels to provide varying functionality. For any given modular truck cap configuration, a replacement section may be readily swapped in place of a counterpart section of the modular truck cap. For example, users may select from side panels having configurations including: (1) a solid panel, to prevent viewing of bed contents when the cap is closed; (2) a panel with glass or plexiglass windowing, to provide light or visibility into the truck bed; (3) a side panel having an opening, lockable hatch to provide side access to the truck bed, or (4) a side panel having storage compartments for storing equipment accessible from outside and/or inside the cap.

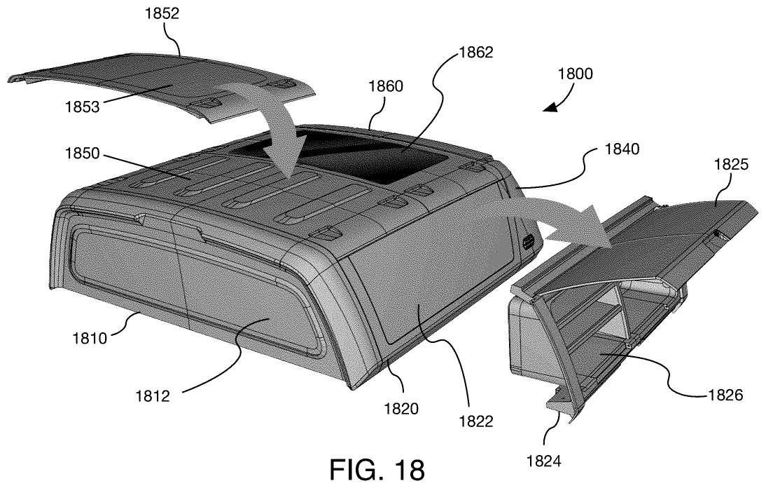

FIG. 18 provides a figurative illustration of a modular truck cap, in a front upper perspective view, with interchangeable panels. In a first configuration as illustrated with installed panels, truck cap 1800 includes a front panel 1810 having a centrally-inset glass pane 1812 to provide visibility from a truck cab into the bed; a left side panel 1820 having a glass pane 1822 to provide light and visibility into the cap; a right side panel (not shown, but analogous to left side panel 1820); a rear panel 1840; a solid top panel 1850; and a rear top panel 1860. Rear top panel 1860 includes a glass pane 1862 inset within it, enabling light from above to enter truck cap 1800 when installed. However, solid top panel 1850 may be interchangeably swapped for roof panel 1852, which includes solar panels 1853 exposed in a top side of windowed roof panel 1852, along with integrated power systems to facilitate e.g. charging of batteries or devices stored within truck cap 1800 or a truck on which truck cap 1800 is installed, and/or powering of LED lighting on the interior side of one or more panels to illuminate the truck bed. Similarly, if a user of truck cap 1800 desires to store tools, parts or other equipment for ready access from outside a truck, windowed left side panel 1820 may be interchangeably swapped for storage side panel 1824. Storage side panel 1824 includes a lockable hinged door 1825 which may be opened into the configuration illustrated in FIG. 18 to provide access to multiple storage shelves or compartments 1826, or closed to seal the contents of compartments 1826. Thus, a user of truck cap 1800 can easily change its configuration to, e.g., use left side panel 1820 when it is desired to maximize enclosed area within truck cap 1800, or use storage side panel 1824 when it is desired to provide externally-accessible storage compartments.

In yet other configurations, particularly for modular truck caps having two top panels, one of the top panels may be removed entirely during use to provide open access between the truck bed and areas above the modular cap. Such a configuration may be useful e.g. to permit hauling of tall items that extend upward through an opening formed by the removed panel. If one of the two top panels remains installed, the installed top panel may serve to maintain excellent structural rigidity and/or improve airflow over the modular truck cap while driving.

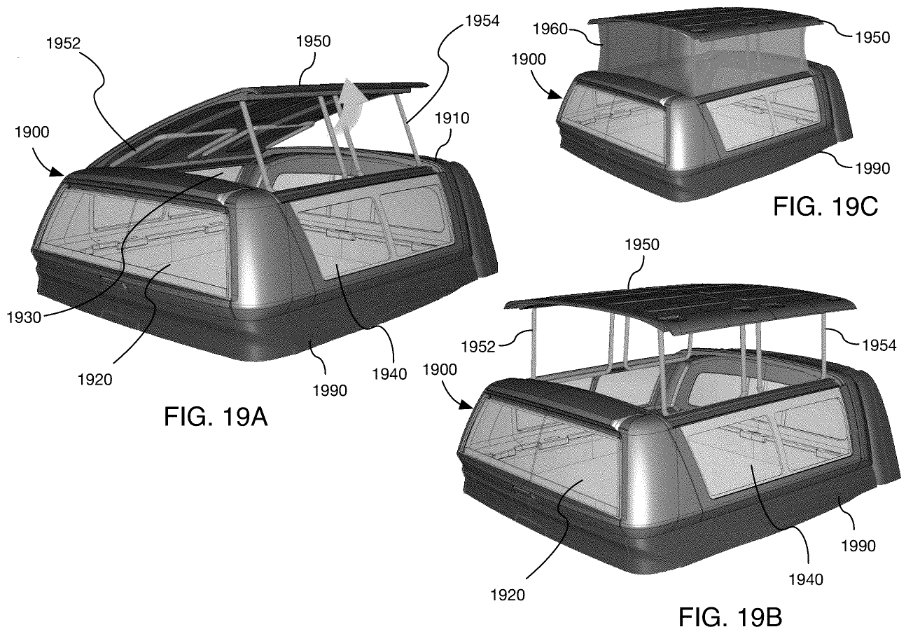

FIGS. 19A, 19B and 19C illustrate yet further modular roof panels that may be installed to implement desired functionality. FIG. 19A shows modular truck cap 1900 in a camping configuration. Modular truck cap 1900 includes windowed front panel 1910, windowed rear panel 1920, windowed left side panel 1930 and windowed right side panel 1940. A single top panel 1950 can be positioned to enclose the bed of truck 1990, or for open configurations allowing open communication between the bed of truck 1990 and areas above modular truck cap 1900. In particular, single top panel 1950 includes configurable legs 1952 on a left side of single top panel 1950, and configurable legs 1954 on a right side of single top panel 1950. Configurable legs 1952 and configurable legs 1954 may be formed from, e.g., metal tubes, and may in some embodiments operate similarly to legs of a folding table. In FIG. 19A, configurable legs 1954 are pivoted down away from the underside of single top panel 1950 and secured to an upper portion of right side panel 1940, providing a “pop-up” roof over the truck bed to e.g. provide ample airflow within the truck bed, while still shielding the bed from sun or direct wind coming from the left side of truck 1990.

FIG. 19B illustrates an alternative configuration of modular truck cap 1900, wherein both configurable legs 1952 and configurable legs 1954 are deployed downwards and secured to an upper portion of their respective left side panel 1930 and right side panel 1940. In that configuration, single top panel 1950 provides a pop-up roof allowing ample airflow into the truck bed from all directions, while still providing some protection from sun, leaves or detritus directly above truck 1990. During travel, both configurable legs 1952 and configurable legs 1954 may be folded flush against single top panel 1950, such that single top panel 1950 is installed to form a flat, enclosed roof for modular truck cap 1900.

In some embodiments, it may be desirable to install mesh mosquito netting or the like, in order to allow airflow into a truck bed when a modular cap is in an open configuration, while minimizing the incursion of insects or the like. FIG. 19C illustrates such a configuration, having the open configuration of FIG. 19B with mesh or fabric curtain 1960 attached between a hard panel surface of single top panel 1950 and upper edges of windowed front panel 1910, windowed rear panel 1920, side panel 1930 and right side panel 1940.

Additionally, single top panel 1950 may be removed entirely from truck 1990, with configurable legs 1952 and configurable legs 1954 all deployed as illustrated in FIG. 19B, with single top panel 1950 being set on the ground for use as a table accessory. Single top panel 1950 may then be reinstalled in modular truck cap 1900 for use as a top panel enclosure. In this way, a user can readily adapt the functionality and configuration of the modular cap, without having to purchase, store and install/uninstall completely independent caps.

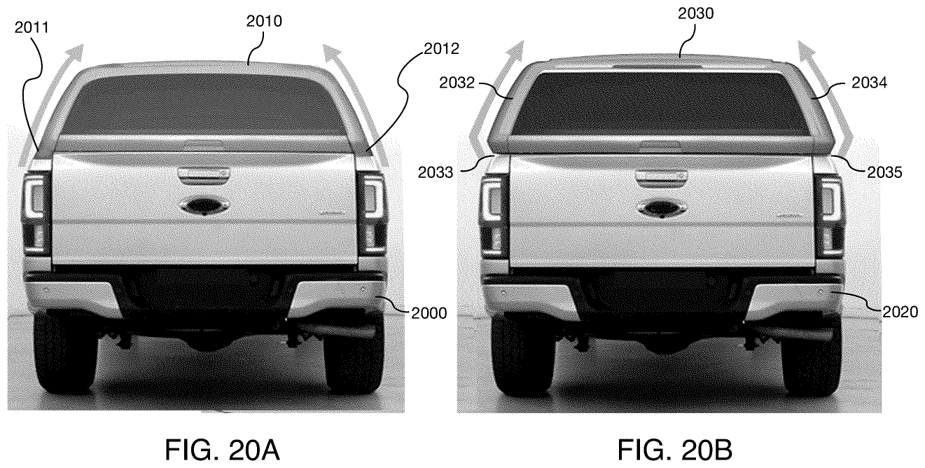

In addition to ease of installation and removal, ease of shipping, ease of storage, adaptable functionality, and other advantages that may be provided by certain modular truck cap embodiments, the modular construction techniques illustrated may also remove certain design constraints that may be inherent in some traditional methods of truck cap fabrication. For example, FIG. 20A illustrates a rear view of a truck 2000 having a traditional, unitary-construction truck bed cap 2010 installed on it. Truck bed cap 2010 narrows continuously from points 2011 and 2012 at which it meets the left and right sides of truck 2000, respectively. In e.g. a molded truck cap construction, such a continuous curve design facilitates removal of unitary-construction truck bed cap 2010 from a mold in which it is formed. However, the width of unitary-construction truck bed cap 2010 is constrained.

By contrast, FIG. 20B illustrates a rear view of a truck 2020 with a modular truck bed cap 2030. Each component of modular truck bed cap 2030 may be shaped with continuously-expanding or continuously-narrowing dimensions to facilitate removal of the individual panel from a mold. However, the panels may be combined to form an overall structure that, for example, expands outward from a truck bed's side rails, before narrowing again towards the truck bed roof. In particular, side panels 2032 and 2034 each bow outward from points 2033 and 2035, respectively, at which they contact the truck bed side rails, before narrowing again towards the roof of modular truck bed cap 2030. This shape creates additional width and volume enclosed within modular truck bed cap 2030.

While certain embodiments of the invention have been described herein in detail for purposes of clarity and understanding, the foregoing description and Figures merely explain and illustrate the present invention and the present invention is not limited thereto. It will be appreciated that those skilled in the art, having the present disclosure before them, will be able to make modifications and variations to that disclosed herein without departing from the scope of the invention or appended claims.

1. A modular truck cap for removable installation on a bed of a truck, comprising:
a front section removably mountable to extend upwards from a front rail of a truck bed;
a left section removably mountable to extend upwards from a left side rail of the truck bed;
a right section removably mountable to extend upwards from a right side rail of the truck bed;
a rear section removably mountable to extend upwards from a rear tailgate of the truck bed; and
one or more roof sections collectively covering at least a portion of a space defined by the front section, rear section, left section and right section, each of said roof sections removably mountable to two or more of said front section, left section, right section and rear section.

2. The modular truck cap of claim 1, in which the one or more roof sections comprise a front top section and a rear top section.

3. The modular truck cap of claim 1, further comprising one or more latches removably attaching the front section, left section and right section to the truck bed.

4. The modular truck cap of claim 3, wherein each latch is pivotably mounted to one of said sections to move between a stowed configuration in which the latch pivots upward against the section to which it is mounted, and a deployed configuration in which the latch is pivoted downward away from the section to which it is mounted.

5. The modular truck cap of claim 3, further comprising one or more mounting points secured to the bed of the truck, wherein each of said latches is mounted to one of the sections, and each of said latches engages one or more of said mounting points to secure the section to which it is mounted to the bed of the truck.

6. The modular truck cap of claim 5, wherein the mounting points comprise one or more sections of strut, L angle, I beam or U channel affixed to front, left and right sides of the bed.

7. The modular truck cap of claim 1, wherein the sections are comprised of fiberglass.

8. The modular truck cap of claim 1, wherein the sections are each formed via molding.

9. The modular truck cap of claim 8, wherein the left section and the right section, when installed, each curve laterally outward from points at which said left section and right section meet the bed.

10. The modular truck cap of claim 1, wherein said front section adjoins with the left section, right section and at least one of the roof sections via portions of said sections mating in tongue and groove structures.

11. The modular truck cap of claim 10, further comprising one or more seals compressed within the tongue and groove structures when assembled.

12. The modular truck cap of claim 1, further comprising a replacement section that may be swapped in place of a counterpart section comprising one or more of the front section, rear section, left section, right section or roof sections; wherein structure of the replacement section differs from the counterpart section.

13. The modular truck cap of claim 12, wherein the counterpart section is opaque and the replacement section comprises a window.

14. The modular truck cap of claim 12, wherein the counterpart section is a side section and the replacement section is a side section comprising a lockable door enclosing one or more storage compartments.

15. The modular truck cap of claim 12, wherein the counterpart section is a roof section and the replacement section is a roof section comprising solar panels.

16. The modular truck cap of claim 12, wherein the counterpart section is a roof section and the replacement section is a roof section movable between a lowered configuration enclosing the truck cap, and one or more raised configurations allowing open communication between the truck bed and areas outside the truck cap.

17. The modular truck cap of claim 16, wherein the replacement section comprises configurable legs which may be deployed from a bottom side of the replacement section and connected to one or more of the side sections.

18. A method for installing a truck cap on a truck bed, comprising:
standing a front section on a front truck bed rail, the front section comprising a forward surface and a shroud extending rearward, the shroud having lower portions contacting portions of left and right truck bed rails;
standing a rear section comprising a rearward surface and a shroud extending forward, on a tailgate of the truck and portions of the left and right truck bed rails;
interlocking a left section with the front section and the rear section, wherein the left section rests on the left truck bed rail; and
interlocking a right section with the front section and the rear section, wherein the right section rests on the right truck bed rail.

19. The method of claim 18, further comprising interlocking one or more top sections with the left section, the right section, and at least one of the front section and the rear section.

20. The method of claim 18, further comprising securing the front section, the rear section, the left section and the right section to the truck bed using a tool-less removable fastener.
